(19) United States
(12) Patent Application Publication
(10) Pub. No.: US 2008/0225055 A1
(43) Pub. Date: Sep. 18, 2008

(54) Method for obtaining primary color values of display device and method for establishing color correction tables of same

(75) Inventors: Hsin-Te Yu, Miao-Li (TW); Li-Hui Lin, Shenzhen (CN); Xiao-Wo Liu, Shenzhen (CN); Yan-An Li, Shenzhen (CN); Xue-Feng Xia, Shenzhen (CN); Jian-Feng Wang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/077,102

(22) Filed: Mar. 17, 2008

(30) Foreign Application Priority Data
Mar. 16, 2007 (CN) 200710073537.0

(51) Int. Cl. G09G 5/02

(52) U.S. Cl. 345/600

(57) ABSTRACT

An exemplary method for obtaining primary color values via measuring color values of a display device, the method including: measuring tristimulus values when the display device respectively displaying a red, green, and blue monochromatic patterns, the red, green, and blue monochromatic patterns respectively having the largest intensity; measuring tristimulus values when the display device displaying a white pattern mixed by the red, green, and blue colors; calculating intensity values of the red, green, and blue colors of the white pattern.

### FIELD OF THE INVENTION

The present invention relates to a method for obtaining primary color values via measuring color values of a display device. The present invention also relates to a method for establishing color correction tables of the display device.

### GENERAL BACKGROUND

Display devices such as cathode ray tube displays, liquid crystal displays, and plasma displays are widely used in modern daily life. Typically, a color display device displays images based on red (R), green (G), and blue (B) primary colors. Each of the primary colors corresponds to a range of intensities called gray levels. Typically, there are 256 gray levels, which range from the 0^{th} gray level to the 255^{th} gray level. Therefore, by mixing the three primary colors, the display device can display images having as many as 16,777,216 (256×256×256) different colors. The intensity of one color selected from the 16,777,216 colors is determined by a total intensity of the three primary colors. The chroma of one color selected from the 16,777,216 colors is determined by a ratio of the respective intensities of the three primary colors.

Due to the non-linear relationship between the input video signals and the output light intensity of the display device, a process of color correction is needed to be performed in the display device so as to convert the non-linear relationship into a linear relationship. Thereby, color correction tables are needed during the process of color correction.

The color correction tables generally include a red, a green, and a blue color correction tables. Each of the color correction tables is obtained by measuring and adjusting the intensities of corresponding monochromatic patterns. Each of the monochromatic patterns corresponds to one of the 256 gray levels. That is, in order to establish the color correction tables, we should measure and adjust the intensities of different monochromatic patterns 768 (256×3) times. This is time consuming and it is disadvantageous in massive production.

What is needed, therefore, is a method for obtaining primary color values via measuring color values of a display device and a method for establishing color correction tables that can overcome the above-described deficiencies.

### SUMMARY

A method for obtaining primary color values via measuring color values of a display device, the method including: measuring tristimulus values when the display device respectively displaying a red, green, and blue monochromatic patterns, the red, green, and blue monochromatic patterns respectively having the largest intensity; measuring tristimulus values when the display device displaying a white pattern mixed by the red, green, and blue colors; calculating intensity values of the red, green, and blue colors of the white pattern.

A method for establishing color correction tables, the method including: providing a display device, a signal generator, and a color analyzer; initializing the display device, the signal generator, and the color analyzer; measuring tristimulus values when the display device respectively displaying a red, green, and blue monochromatic patterns, the red, green, and blue monochromatic patterns respectively having the largest intensity; measuring tristimulus values when the display device displaying 2ⁿ white patterns corresponding to 2ⁿ different gray levels, each of the white patterns being mixed by red, green, and blue primary colors; calculating intensity values of the red, green, and blue primary colors of the 2ⁿ white patterns, respectively; obtaining color correction curves of red, green, and blue primary colors by arithmetic interpolating among the gray levels of the 2ⁿ white patterns; obtaining ideal color correction curves of red, green, and blue primary colors, respectively; storing 256 gray levels on the color correction curves of the red, green, and blue colors respectively, the 256 gray levels having intensity values that are closest to the intensity values of the gray level 0 through the gray level 255 on the corresponding ideal color correction curves; establishing the red color correction table, the green color correction table, and the blue color correction table, respectively; establishing the color correction tables of the display device.

Other novel features and advantages will become more apparent from the following detailed description when taken in conjunction with the accompanying drawings.

### BRIEF DESCRIPTION OF THE DRAWINGS

FIG. 1 is a flowchart summarizing a method for establishing color correction tables of a display device according to a first embodiment of the present invention.

FIG. 2 is a flowchart showing detailed steps of obtaining intensity values of red, green, and blue primary colors corresponding to a white test pattern.

FIG. 3 shows a method for generating a color correction curve corresponding to the red primary color.

FIG. 4 is a flowchart showing detailed steps of obtaining color correction tables.

FIG. 5 shows a method for correcting a gray level.

### DETAILED DESCRIPTION OF PREFERRED EMBODIMENTS

Reference will now be made to the drawings to describe the preferred and exemplary embodiments in detail.

A system for the present invention includes a display device, a video signal generator, a color analyzer, and a computer. The video signal generator generates test video signals, and the display device displays test patterns according to the test video signals received from the video signal generator. The color analyzer is provided for measuring the intensity values of the test patterns. In the present invention, the color analyzer is used in the XYZ color space. The XYZ color space allows colors to be expressed as a mixture of three tristimulus values X, Y, and Z. The tristimulus values X, Y, and Z come from the fact that color perception results from the retina of the eye responding to three types of stimuli. Therefore, the tristimulus values X, Y, and Z represent the intensity values of the test patterns. The computer is provided for processing the tristimulus values X, Y, and Z received from the color analyzer.

The computer includes a video graphics array (VGA) display card, and a register for storing the tristimulus values X, Y, and Z. The video signal generator may be the VGA display card of the computer. The display device includes a memory for storing color correction tables. The color analyzer includes a main body and a detector. The detector is disposed adjacent to the central portion of the display area of the display device for measuring the tristimulus values X, Y, and Z of the test patterns.

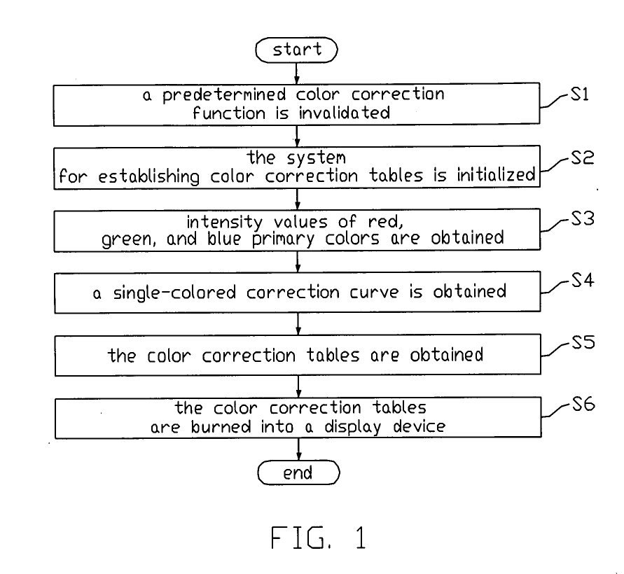

FIG. 1 is a flowchart summarizing a method for establishing the color correction tables of the display device according to a first embodiment of the present invention. The method includes the following steps. Step S1: the predetermined color correction function of the display device is invalidated. If the display device includes predetermined color correction tables, the predetermined color correction function that originally installed in the display device is invalidated before the display device is turned on.

Step S2: the system for establishing the color correction tables is initialized. The video signal generator, the color analyzer, the computer, and the display device are initialized. The video signal generator generates red, green, and blue video signals to enable the display device to display different white test patterns that corresponds to the 0^{th}, the 4^{th}, the 8^{th}, . . . , the 248^{th}, and the 252^{nd}gray levels, respectively. The total number of the white test patterns is 64. The video signals are sequentially applied to the display device.

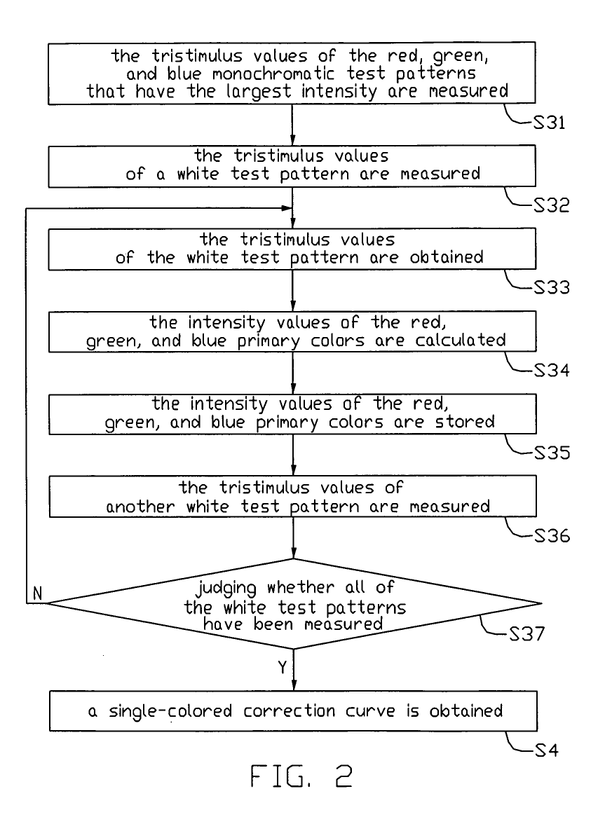

Step S3: the intensity values of the red, green, and blue primary colors that corresponds to the white patterns are obtained. Referring to FIG. 2, this is a flowchart showing detailed steps of the step S3.

Step S31: the tristimulus values of the red, green, and blue monochromatic test patterns that have the largest intensity are measured. The video signal generator generates signals to enable the display device to respectively display red, green, and blue monochromatic test patterns that have the largest intensity. When the display device displays the red monochromatic pattern, the color analyzer measures three tristimulus values Xr, Yr, and Zr. Similarly, when the display device respectively displays the green and blue monochromatic patterns, the color analyzer measures tristimulus values Xg, Yg, Zg and Xb, Yb, Zb. The measured tristimulus values Xr, Yr, Zr, Xg, Yg, Zg, Xb, Yb, Zb are stored in the register of the computer.

Step S32: the tristimulus values of a white test pattern corresponding to the i^{th} (where i is selected from the range of 0, 4, 8, . . . , 248, 252) gray level are measured. The video signal generator generates a video signal corresponding to the i^{th} gray level. The display device displays the i^{th} white test pattern according to the video signal.

Step S33: the tristimulus values of the white test pattern of the display device are obtained. When the display device displays the white test pattern, the color analyzer measures the tristimulus values Xi, Yi, Zi of the white test pattern. The tristimulus values Xi, Yi, Zi are stored in the register of the computer.

Step S34: the intensity values of the red, green, and blue primary colors according to the tristimulus values Xi, Yi, Zi of the white test pattern are calculated. The percentage values Kri, Kgi, Kbi of the intensities of the three primary colors in the white test pattern are obtained by the following equation:

$$[ \begin{matrix}Kri \\ Kgi \\ Kbi\end{matrix} ] = {[ \begin{matrix}Xr & Xg & Xb \\ Yr & Yg & Yb \\ Zr & Zg & Zb\end{matrix} ]}^{- 1} * [ \begin{matrix}Xi \\ Yi \\ Zi\end{matrix} ] \qquad ( 1 )$$

Thereby, the intensity values Lri, Lgi, Lbi of the red, green, and blue primary colors are obtained by the following equation:

$$[ \begin{matrix}Lri \\ Lgi \\ Lbi\end{matrix} ] = {[ \begin{matrix}Xr & Xg & Xb \\ Yr & Yg & Yb \\ Zr & Zg & Zb\end{matrix} ]}^{- 1} * [ \begin{matrix}Xi \\ Yi \\ Zi\end{matrix} ] * [ \begin{matrix}Yr & Yg & Tb\end{matrix} ] \qquad ( 2 )$$

The process of calculating the intensity values Lri, Lgi, Lbi can be executed by computer program according to the equation (2).

Step S35: the intensity values of the red, green, and blue primary colors are stored. The intensity values Lri, Lgi, Lbi of the red, green, and blue primary colors obtained in the step S34 are stored in the register of the computer.

Step S36: the tristimulus values of another white test pattern corresponding to the (i+4)^{th} gray level are measured. The video signal generator generates a video signal corresponding to the (i+4)^{th} gray level. The display device displays the (i+4)^{th} white test pattern according to the video signal.

Step S37: judging whether all of the white test patterns displayed by the display device have been measured by the color analyzer. If the number of the intensity values Lri of the red primary colors stored in the register is equal to 64, the process of measuring the intensity values of the white test pattern is finished, and the procedure goes to step S4. If the number of the intensity values Lri of the red primary colors stored in the register is smaller than 64, the process of measuring the intensity values is not finished, and the procedure goes back to the step S33.

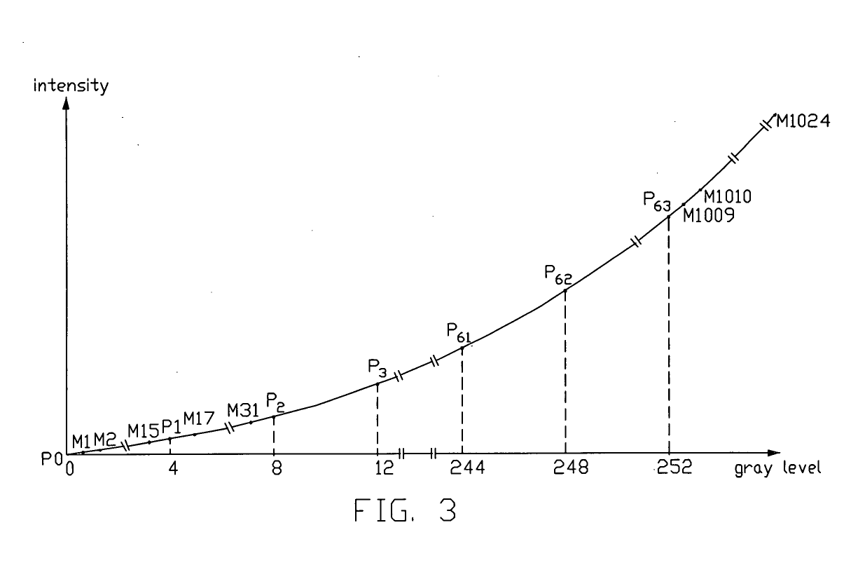

Step S4: referring also to FIG. 3, a single-colored correction curve is obtained. In this embodiment, a red correction curve is obtained. In detail, the red correction curve is obtained according to an arithmetic interpolating method. Horizontal coordinate values of the red correction curve represent different gray levels. Vertical coordinate values of the red correction curve represent different intensity values corresponding to the reference gray levels. In particular, 64 points, P0 to P63, respectively represent 64 different intensity values of the red primary color measured in the step S3. The points P0 to P63 corresponds to the 0^{th}, the 4^{th}, the 8^{th}, . . . , the 248^{th}, and the 252^{nd} gray levels, respectively. The points P0, P1, P2 define a first bezier curve. Part of the first bezier curve between the points P0 and P1 is divided into 16 equal parts in the gray level direction by 15 points, M1 through M15. The points P1, P2, P3 define a second bezier curve. Part of the second bezier curve between the points P1 and P2 is divided into 16 equal parts in the gray level direction by 15 points, M17 through M31. Similarly, each bezier curve between two adjacent points is divided into 16 equal parts by 15 points. The points P61, P62, P63 define a final bezier curve. Beyond the point P63, 16 further points, M1009 through M1024, are arranged sequentially on the final bezier curve, such that there are 16 equal parts between the point P63 and the point M1024. The 16 equal parts between the point P63 and the point M1024 have the same length as the 16 equal parts between the points P0 and P1 in the gray level direction. Thereby, there are a total of 1024 points, being the points P0 through P63 and the points M0 through M1024. By connecting the 1024 points sequentially, the red correction curve is obtained.

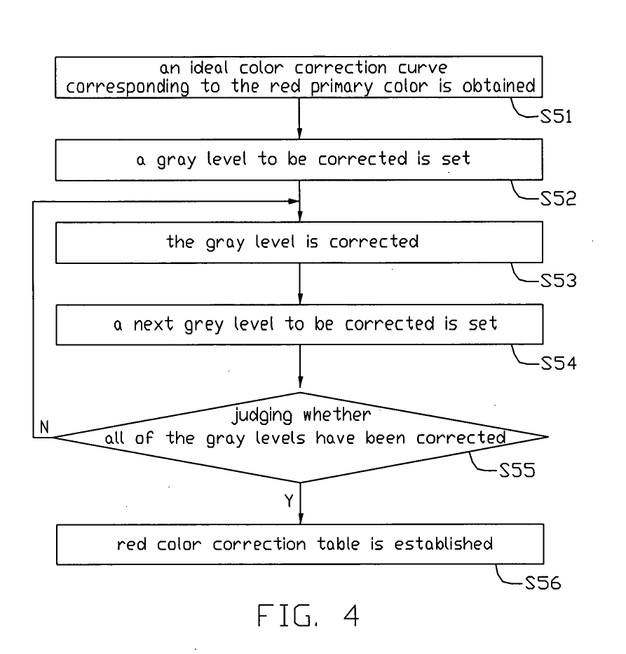

Step S5: the color correction tables are obtained. Referring also to FIG. 4, this is a flowchart showing the detailed steps of the step S5. An ideal color correction curve corresponding to the red primary color is obtained in Step S51. The ideal color correction curve corresponding to the red primary color is obtained by the following equation:

Ln=(Lmax−Lmin)(n/255)̂gamma+Lmin, (3)

where Lmax represents the largest intensity value of the red monochromatic pattern displayed by the display device, Lmin represents the smallest intensity value of the red monochromatic pattern displayed by the display device, the variable n is a whole number in the range from 0 to 255 representing the number of gray levels. Ln represents the intensity value of a red monochromatic pattern corresponding the n^{th} gray level. Gamma is a constant, which is equal to 2.2. When n is counted from 0 to 255, corresponding intensity values L0, L1, . . . , L254, L255 are calculated according to the equation (3). The values L0, L1, . . . , L254, L255 together with corresponding gray levels define the ideal color correction curve of the red primary color. The ideal color correction curve has horizontal coordinate values n representing different gray levels, and vertical coordinate values L representing corresponding intensity values.

Step S52: a gray level n (where n is a whole number, and 0≦n≦255) to be corrected is set. The gray level n of the red primary color to be corrected on the red correction is set.

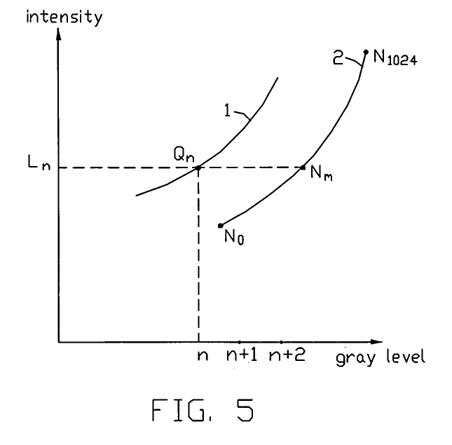

Step S53: the gray level of the red primary color according to the ideal color correction curve obtained in the step S51 is corrected. Referring to FIG. 5, the ideal color correction curve 1 obtained in the step S51 and the red correction curve 2 obtained in the step S4 are set together in a same coordinate plane. Horizontal coordinate values represent the different gray levels from 0 to 255. Vertical coordinate values represent the corresponding intensity values. Ln represents the intensity value of the n^{th} gray level of the red primary color. Points N0 through N1023 (1024 points in total) are sequentially arranged in the red color correction curve 2, which points respectively correspond to the points M1 through M1024 and the points P0 through P63 in the step S4. The intensity value Ln and the corresponding gray level n define a point Qn on the ideal color correction curve 1. A point Nm (0≦m≦1023) on the red color correction curve 2 has an intensity value that is closest to the intensity value of the n^{th} gray level (corresponding to the point Qn). The gray level corresponding to the point Nm is stored in the register of the computer. Thus, the n^{th} gray level is corrected.

Step S54: a next gray level to be corrected is set. The next gray level of the red primary color to be corrected is set.

Step S55: judging whether all of the gray levels have been corrected. If the number of the next gray level is in excess of 255, all the gray levels 0 through 255 have been corrected, the procedure goes to step S56. If the number of the next gray level is not in excess of 255, the procedure goes back to step S53.

Step S56: the red color correction table is established. The 256 gray levels stored in the register of the computer are arranged in that order from smallest to largest, and these gray levels together constitute the red color correction table. Similarly to step S4 through step S56, a green color correction table and a blue color correction table can be obtained. Then color correction tables are established by putting together the red, green, and blue color correction tables.

Step S6: the color correction tables obtained in the step S56 are burned into the memory of the display device.

Instead of measuring all the intensity values of the 256 gray levels of the three primary colors, the color analyzer of the present invention only measures the tristimulus values of the white test patterns corresponding to the 0^{th}, the 4^{th}, the 8^{th}, . . . , the 248^{th}, and the 252^{nd} gray levels. The intensity values of the three primary colors corresponding to the white test patterns are obtained by method of calculating and interpolation. That is, the color analyzer only measures 64 times of the white test patterns. Because the color analyzer only measures 64 times and the calculation and interpolation processes are executed by the computer, the time for establishing the color correction tables are reduced. As a result, each display device may have suitable color correction tables in a short time. This improves the characteristic of the display device and is advantageous in mass production of the display devices.

The present invention has a second embodiment for establishing color correction tables. The method is similar to the method described in the first embodiment. However, in step of forming an ideal color correction curve, the ideal color correction curve is obtained by the following equations:

Ltotal=Lr255+Lg255+Lg255=Lw255 (4)

Kr255=Lr255/Ltotal (5)

Where Lr255, Lg255, Lg255 represent the largest intensities when the display device respectively display red, green, and blue monochromatic test patterns. Lw255 represents the intensity value of a white pattern mixed by the red, green, and blue primary colors that respectively have the largest intensity values. Kr255 represents a percentage value of the intensity of the red primary color in the white pattern. As a result, the intensity value Lrn of the red primary color corresponding to the n^{th} gray level is obtained according to the following equation:

Lrn=Kr255*Lwn (6)

Where Lwn represents a measured intensity value of a white pattern corresponding to the n^{th} gray level. When n is counted from 0 to 255, corresponding intensity values Lr0, Lr1, . . . , Lr254, Lr255 are calculated according to the equation (6). The values Lr0, Lr1, . . . , Lr254, Lr255 together with corresponding gray levels define the ideal color correction curve of the red primary color. The ideal color correction curve has horizontal coordinate values n representing different gray levels, and vertical coordinate values L representing corresponding intensity values. Similarly, the ideal color correction curves of the green and blue primary colors can be obtained.

Using the equations (4), (5), (6), the percentage values of the intensities of the red primary color in the 256 white patterns are equal to Kr255. Similarly, the percentage values of the intensities of the green and blue primary color in the 256 white patterns are constant. Therefore, different white patterns mixed by the red, green, and blue primary colors have the same chroma. That is, color correction tables established according to the equations (4), (5), (6) are more accurate. As a result, display devices using the color correction tables display images having accurate color performance.

Various modifications and alterations to the above-described embodiments are possible. For example, in step S3, the color analyzer may measure 32 or 128 or 2ⁿ (1≦2ⁿ≦256) different white patterns corresponding to different gray levels. In step S4, the color correction curve may be obtained by equally dividing a line between two successive points.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for obtaining primary color values via measuring color values of a display device, the method comprising:
measuring tristimulus values when the display device respectively displaying a red, green, and blue monochromatic patterns, the red, green, and blue monochromatic patterns respectively having the largest intensity;
measuring tristimulus values when the display device displaying a white pattern mixed by the red, green, and blue colors;
calculating intensity values of the red, green, and blue colors of the white pattern.

2. The method as claimed in claim 1, wherein the tristimulus values are measured in the XYZ color space.

3. The method as claimed in claim 2, wherein the intensity values of the red, green, and blue colors of the white pattern are calculated by the following equation:
$$[ \begin{matrix}Lri \\ Lgi \\ Lbi\end{matrix} ] = {[ \begin{matrix}Xr & Xg & Xb \\ Yr & Yg & Yb \\ Zr & Zg & Zb\end{matrix} ]}^{- 1} * [ \begin{matrix}Xi \\ Yi \\ Zi\end{matrix} ] * [ \begin{matrix}Yr & Yg & Tb\end{matrix} ] ,$$
where Xr, Yr, Zr, Xg, Yg, Zg, and Xb, Yb, Zb respectively represent the tristimulus values of the red, green, and blue monochromatic patterns, Xi, Yi, Zi represent the tristimulus values of the white pattern, Lri, Lgi, Lbi represent the intensity values of the red, green, and blue primary colors of the white pattern.

4. A method for establishing color correction tables, the method comprising:
providing a display device, a signal generator, and a color analyzer;
initializing the display device, the signal generator, and the color analyzer;
measuring tristimulus values when the display device respectively displaying a red, green, and blue monochromatic patterns, the red, green, and blue monochromatic patterns respectively having the largest intensity;
measuring tristimulus values when the display device displaying 2ⁿ white patterns corresponding to 2ⁿ different gray levels, each of the white patterns being mixed by red, green, and blue primary colors;
calculating intensity values of the red, green, and blue primary colors of the 2ⁿ white patterns, respectively;
obtaining color correction curves of red, green, and blue primary colors by arithmetic interpolating among the gray levels of the 2ⁿ white patterns;
obtaining ideal color correction curves of red, green, and blue primary colors, respectively;
storing 256 gray levels on the color correction curves of the red, green, and blue colors respectively, the 256 gray levels having intensity values that are closest to the intensity values of the gray level 0 through the gray level 255 on the corresponding ideal color correction curves;
establishing the red color correction table, the green color correction table, and the blue color correction table, respectively;
establishing the color correction tables of the display device.

5. The method as claimed in claim 4, wherein if the display device comprises predetermined color correction tables, invalidates the predetermined color correction function of the display device before initializing the display device, the signal generator, and the color analyzer.

6. The method as claimed in claim 4, wherein the tristimulus values are measured via the color analyzer in the XYZ color space.

7. The method as claimed in claim 4, wherein the display device displays 64 white patterns corresponding to the 0^{th}, the 4^{th}, the 8^{th}, . . . , the 248^{th}, and the 252^{nd} gray levels, the color analyzer measures the tristimulus values of the 64 white patterns, respectively.

8. The method as claimed in claim 4, wherein the intensity values of the red, green, and blue primary colors of the white pattern are calculated by the following equation:
$$[ \begin{matrix}Lri \\ Lgi \\ Lbi\end{matrix} ] = {[ \begin{matrix}Xr & Xg & Xb \\ Yr & Yg & Yb \\ Zr & Zg & Zb\end{matrix} ]}^{- 1} * [ \begin{matrix}Xi \\ Yi \\ Zi\end{matrix} ] * [ \begin{matrix}Yr & Yg & Tb\end{matrix} ] ,$$
where Xr, Yr, Zr, Xg, Yg, Zg, and Xb, Yb, Zb respectively represent the tristimulus values of the red, green, and blue monochromatic patterns, Xi, Yi, Zi represent the tristimulus values of the white pattern, Lri, Lgi, Lbi represent the intensity values of the red, green, and blue primary colors of the white pattern.

9. The method as claimed in claim 4, wherein the red, green, and blue color correction curves are respectively obtained by an arithmetic method of Bezier interpolation.

10. The method as claimed in claim 9, wherein the Bezier interpolation is performed by equally dividing each part of a bezier curve that between two adjacent gray levels, the two adjacent gray levels corresponds to two of the 2ⁿ white patterns.

11. The method as claimed in claim 10, wherein the bezier curve is equally divided in the gray level direction.

12. The method as claimed in claim 10, wherein each part of the bezier curve is divided into 16 equal parts.

13. The method as claimed in claim 4, wherein the red, green, and blue color correction curves are respectively obtained by an arithmetic method of linear interpolation.

14. The method as claimed in claim 4, wherein the ideal color correction curves of red, green, and blue primary colors are respectively obtained by the following equation:
Ln=(Lmax−Lmin)(n/255)̂gamma+Lmin,
Where Lmax represents the largest intensity value of corresponding monochromatic pattern displayed by the display device, Lmin represents the smallest intensity value of the corresponding monochromatic pattern displayed by the display device, the variable n is a whole number in the range from 0 to 255 representing the number of gray levels, Ln represents an intensity value of the monochromatic pattern corresponding to the n^{th} gray level, gamma is a constant, which is equal to 2.2.

15. The method as claimed in claim 4, wherein the ideal color correction curves of red color is obtained by the following equation:
Ltotal=Lr255+Lg255+Lg255=Lw255,
Kr255=Lr255/Ltotal,
Lrn=Kr255*Lwn
where Lr255, Lg255, Lg255 represent the largest intensities when the display device respectively display red, green, and blue monochromatic patterns, Lw255 represents the intensity value of a white pattern mixed by the red, green, and blue primary colors that respectively have the largest intensity values, Kr255 represents percentage values of the intensity of the red color in the white pattern, Lrn represent an intensity value of the red color in a white pattern corresponding to the n^{th} gray level, Lwn represents a measured intensity value of the white pattern corresponding to the n^{th} gray level.

16. The method as claimed in claim 14, wherein percentage values of the intensities of the red, green and blue primary colors in different white patterns are constant.
